(19) United States
(12) Patent Application Publication
(10) Pub. No.: US 2023/0309110 A1
(43) Pub. Date: Sep. 28, 2023

(54) PHYSICAL UPLINK SHARED CHANNEL REPETITIONS

(71) Applicant: QUALCOMM Incorporated, San Diego, CA (US)

(72) Inventors: Mostafa KHOSHNEVISAN, San Diego, CA (US); Yitao CHEN, San Diego, CA (US); Xiaoxia ZHANG, San Diego, CA (US); Fang YUAN, Beijing (CN); Tao LUO, San Diego, CA (US)

(21) Appl. No.: 18/041,655

(22) PCT Filed: Oct. 3, 2020
(86) PCT No.: PCT/CN2020/119802

§ 371 Date: Feb. 14, 2023

(51) Int. Cl. H04W 72/231; H04W 72/1268; H04B 7/06

(52) U.S. Cl. CPC H04W 72/231; H04W 72/1268; H04B 7/0639

(57) ABSTRACT

Various aspects of the present disclosure generally relate to wireless communication. In some aspects, a user equipment (UE) may receive information indicating a quantity of repetitions for a physical uplink shared channel transmission that are to be transmitted in at least one time interval that includes time resources configured for downlink communication. The UE may transmit the quantity of repetitions, in respective time intervals that do not include time resources configured for downlink communication, using frequency hopping that is based at least in part on an indexing of the respective time intervals. Numerous other aspects are provided.

### FIELD OF THE DISCLOSURE

Aspects of the present disclosure generally relate to wireless communication and to techniques and apparatuses for physical uplink shared channel (PUSCH) repetitions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving information indicating a quantity of repetitions for a physical uplink shared channel (PUSCH) transmission, where at least one repetition, of the quantity of repetitions, is to be transmitted in a time interval that includes time resources configured for downlink communication; and transmitting the quantity of repetitions, in respective time intervals that do not include time resources configured for downlink communication, using frequency hopping that is based at least in part on an indexing of the respective time intervals.

In some aspects, a method of wireless communication performed by a UE includes receiving information indicating a periodicity for occasions of a configured grant, where the periodicity for the occasions of the configured grant indicates a quantity of time intervals; and transmitting one or more first repetitions, of a PUSCH transmission for an occasion of the configured grant, in respective time intervals that do not include time resources configured for downlink communication, and dropping one or more second repetitions, of the PUSCH transmission for the occasion of the configured grant, that are not transmitted within the quantity of time intervals.

In some aspects, a method of wireless communication performed by a UE includes receiving information that schedules a first set of repetitions of a PUSCH transmission with a first set of transmission parameters and a second set of repetitions of the PUSCH transmission with a second set of transmission parameters; and transmitting repetitions of the first set of repetitions and the second set of repetitions in respective time intervals, where at least one repetition of each of the first set of repetitions and the second set of repetitions is transmitted in a first frequency hop and at least one repetition of each of the first set of repetitions and the second set of repetitions is transmitted in a second frequency hop.

In some aspects, a UE for wireless communication includes a memory and one or more processors operatively coupled to the memory, the memory and the one or more processors configured to: receive information indicating a quantity of repetitions for a PUSCH transmission, where at least one repetition, of the quantity of repetitions, is to be transmitted in a time interval that includes time resources configured for downlink communication; and transmit the quantity of repetitions, in respective time intervals that do not include time resources configured for downlink communication, using frequency hopping that is based at least in part on an indexing of the respective time intervals.

In some aspects, a UE for wireless communication includes a memory and one or more processors operatively coupled to the memory, the memory and the one or more processors configured to: receive information indicating a periodicity for occasions of a configured grant, where the periodicity for the occasions of the configured grant indicates a quantity of time intervals; and transmit one or more first repetitions, of a PUSCH transmission for an occasion of the configured grant, in respective time intervals that do not include time resources configured for downlink communication, and dropping one or more second repetitions, of the PUSCH transmission for the occasion of the configured grant, that are not transmitted within the quantity of time intervals.

In some aspects, a UE for wireless communication includes a memory and one or more processors operatively coupled to the memory, the memory and the one or more processors configured to: receive information that schedules a first set of repetitions of a PUSCH transmission with a first set of transmission parameters and a second set of repetitions of the PUSCH transmission with a second set of transmission parameters; and transmit repetitions of the first set of repetitions and the second set of repetitions in respective time intervals, where at least one repetition of each of the first set of repetitions and the second set of repetitions is transmitted in a first frequency hop and at least one repetition of each of the first set of repetitions and the second set of repetitions is transmitted in a second frequency hop.

In some aspects, a non-transitory computer-readable medium storing a set of instructions for wireless communication includes one or more instructions that, when executed by one or more processors of a UE, cause the UE to: receive information indicating a quantity of repetitions for a PUSCH transmission, where at least one repetition, of the quantity of repetitions, is to be transmitted in a time interval that includes time resources configured for downlink communication; and transmit the quantity of repetitions, in respective time intervals that do not include time resources configured for downlink communication, using frequency hopping that is based at least in part on an indexing of the respective time intervals.

In some aspects, a non-transitory computer-readable medium storing a set of instructions for wireless communication includes one or more instructions that, when executed by one or more processors of an UE, cause the UE to: receive information indicating a periodicity for occasions of a configured grant, where the periodicity for the occasions of the configured grant indicates a quantity of time intervals; and transmit one or more first repetitions, of a PUSCH transmission for an occasion of the configured grant, in respective time intervals that do not include time resources configured for downlink communication, and dropping one or more second repetitions, of the PUSCH transmission for the occasion of the configured grant, that are not transmitted within the quantity of time intervals.

In some aspects, a non-transitory computer-readable medium storing a set of instructions for wireless communication includes one or more instructions that, when executed by one or more processors of an UE, cause the UE to: receive information that schedules a first set of repetitions of a PUSCH transmission with a first set of transmission parameters and a second set of repetitions of the PUSCH transmission with a second set of transmission parameters; and transmit repetitions of the first set of repetitions and the second set of repetitions in respective time intervals, where at least one repetition of each of the first set of repetitions and the second set of repetitions is transmitted in a first frequency hop and at least one repetition of each of the first set of repetitions and the second set of repetitions is transmitted in a second frequency hop.

In some aspects, an apparatus for wireless communication includes means for receiving information indicating a quantity of repetitions for a PUSCH transmission, where at least one repetition, of the quantity of repetitions, is to be transmitted in a time interval that includes time resources configured for downlink communication; and means for transmitting the quantity of repetitions, in respective time intervals that do not include time resources configured for downlink communication, using frequency hopping that is based at least in part on an indexing of the respective time intervals.

In some aspects, an apparatus for wireless communication includes means for receiving information indicating a periodicity for occasions of a configured grant, where the periodicity for the occasions of the configured grant indicates a quantity of time intervals; and means for transmitting one or more first repetitions, of a PUSCH transmission for an occasion of the configured grant, in respective time intervals that do not include time resources configured for downlink communication, and dropping one or more second repetitions, of the PUSCH transmission for the occasion of the configured grant, that are not transmitted within the quantity of time intervals.

In some aspects, an apparatus for wireless communication includes means for receiving information that schedules a first set of repetitions of a PUSCH transmission with a first set of transmission parameters and a second set of repetitions of the PUSCH transmission with a second set of transmission parameters; and means for transmitting repetitions of the first set of repetitions and the second set of repetitions in respective time intervals, where at least one repetition of each of the first set of repetitions and the second set of repetitions is transmitted in a first frequency hop and at least one repetition of each of the first set of repetitions and the second set of repetitions is transmitted in a second frequency hop.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIG. 3 is a diagram illustrating an example of configured grant (CG) communication, in accordance with various aspects of the present disclosure.

FIG. 4 is a diagram illustrating examples of physical uplink repetition types, in accordance with various aspects of the present disclosure.

FIGS. 5-7 are diagrams illustrating examples associated with physical uplink shared channel (PUSCH) repetitions, in accordance with various aspects of the present disclosure.

FIGS. 8-10 are diagrams illustrating example processes associated with PUSCH repetitions, in accordance with various aspects of the present disclosure.

FIG. 11 is a diagram of an example apparatus for wireless communication, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

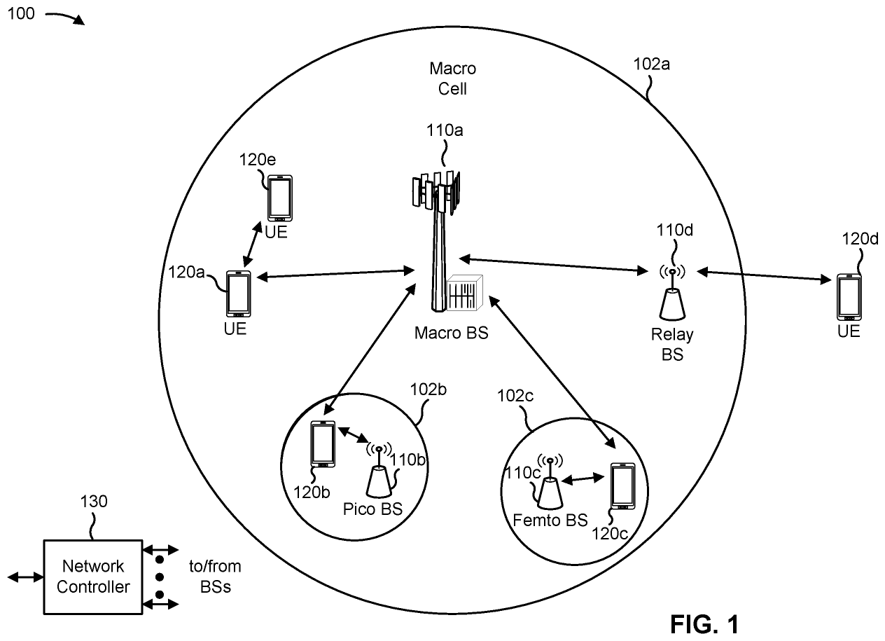

FIG. 1 is a diagram illustrating an example of a wireless network 100, in accordance with various aspects of the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband interne of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, and/or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz — 300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

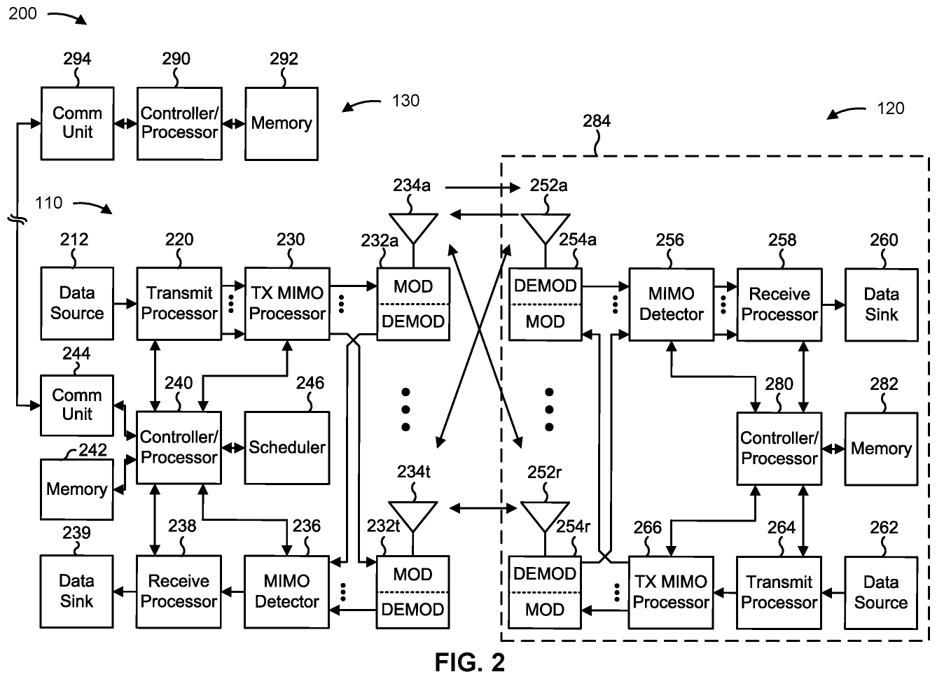

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T>1 and R>1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., a cell-specific reference signal (CRS), a demodulation reference signal (DMRS), and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

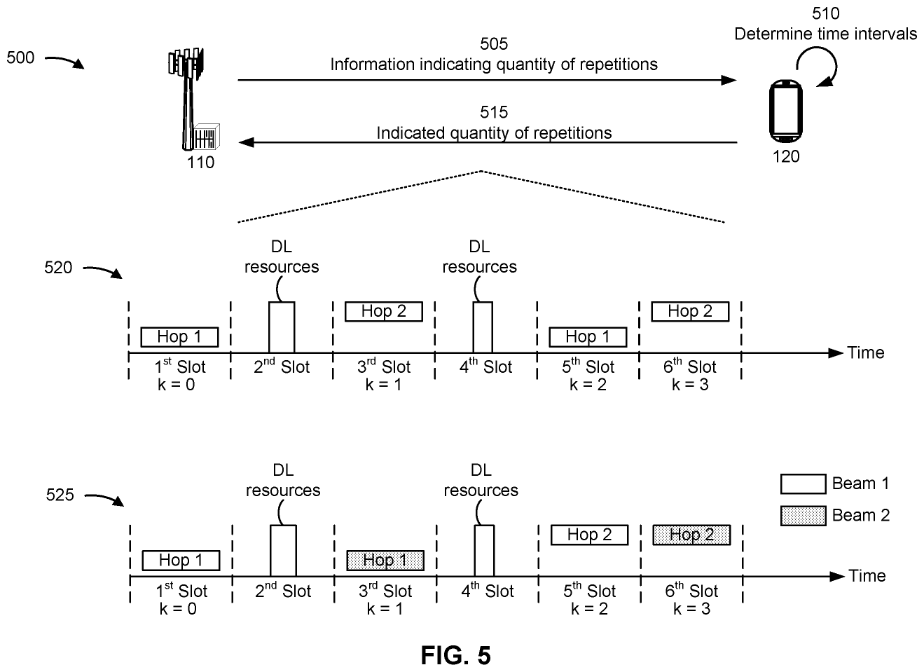

On the uplink, at UE 120, a transmit processor 264 may receive and process data from a data source 262 and control information (e.g., for reports that include RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 5-10.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 5-10.

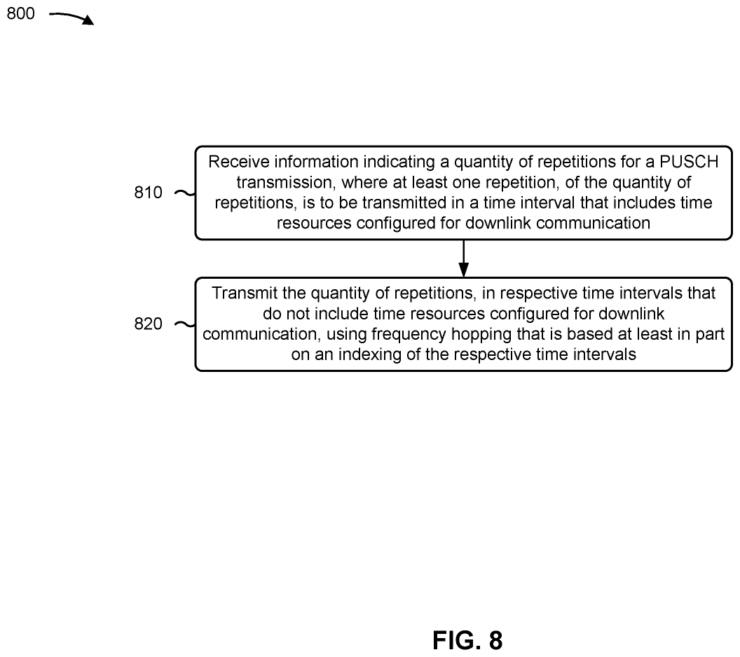

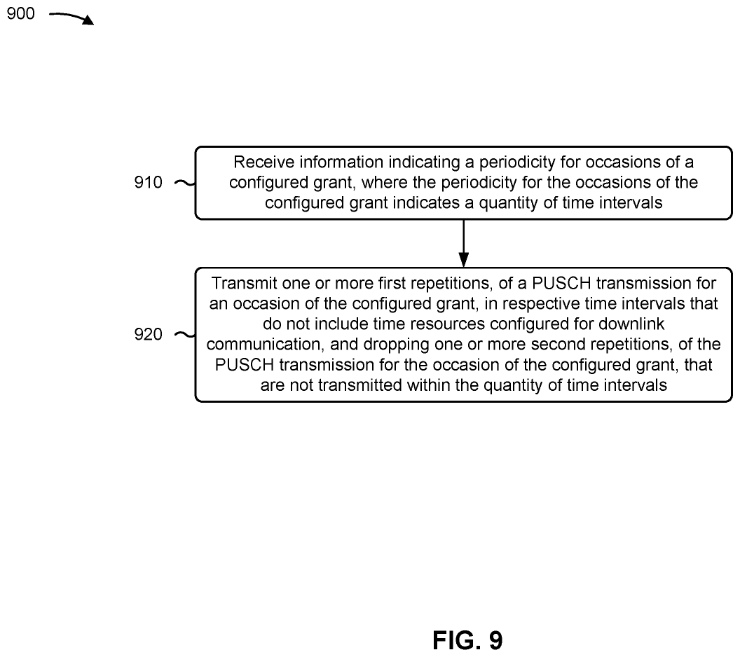

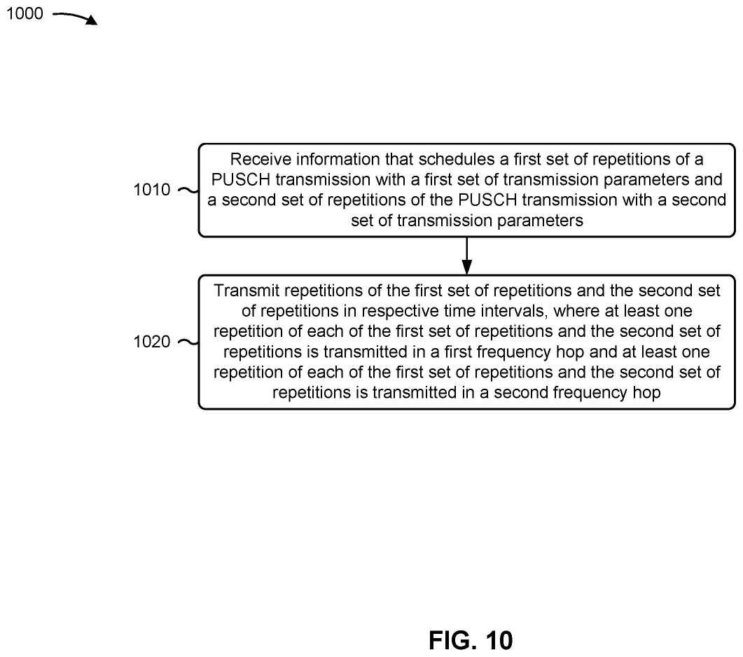

Controller/processor 240 of base station 110, controller/processor 280 of UE 120, and/or any other component(s) of FIG. 2 may perform one or more techniques associated with physical uplink shared channel (PUSCH) repetitions, as described in more detail elsewhere herein. For example, controller/processor 240 of base station 110, controller/processor 280 of UE 120, and/or any other component(s) of FIG. 2 may perform or direct operations of, for example, process 800 of FIG. 8, process 900 of FIG. 9, process 1000 of FIG. 10, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code, program code, and/or the like) for wireless communication. For example, the one or more instructions, when executed (e.g., directly, or after compiling, converting, interpreting, and/or the like) by one or more processors of the base station 110 and/or the UE 120, may cause the one or more processors, the UE 120, and/or the base station 110 to perform or direct operations of, for example, process 800 of FIG. 8, process 900 of FIG. 9, process 1000 of FIG. 10, and/or other processes as described herein. In some aspects, executing instructions may include running the instructions, converting the instructions, compiling the instructions, interpreting the instructions, and/or the like.

In some aspects, the UE includes means for receiving information indicating a quantity of repetitions for a PUSCH transmission, where at least one repetition, of the quantity of repetitions, is to be transmitted in a time interval that includes time resources configured for downlink communication; and/or means for transmitting the quantity of repetitions, in respective time intervals that do not include time resources configured for downlink communication, using frequency hopping that is based at least in part on an indexing of the respective time intervals. In some aspects, the UE includes means for receiving information indicating a periodicity for occasions of a configured grant, where the periodicity for the occasions of the configured grant indicates a quantity of time intervals; and/or means for transmitting one or more first repetitions, of a PUSCH transmission for an occasion of the configured grant, in respective time intervals that do not include time resources configured for downlink communication, and dropping one or more second repetitions, of the PUSCH transmission for the occasion of the configured grant, that are not transmitted within the quantity of time intervals. In some aspects, the UE includes means for receiving information that schedules a first set of repetitions of a PUSCH transmission with a first set of transmission parameters and a second set of repetitions of the PUSCH transmission with a second set of transmission parameters; and/or means for transmitting repetitions of the first set of repetitions and the second set of repetitions in respective time intervals, where at least one repetition of each of the first set of repetitions and the second set of repetitions is transmitted in a first frequency hop and at least one repetition of each of the first set of repetitions and the second set of repetitions is transmitted in a second frequency hop. The means for the UE to perform operations described herein may include, for example, antenna 252, demodulator 254, MIMO detector 256, receive processor 258, transmit processor 264, TX MIMO processor 266, modulator 254, controller/processor 280, and/or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

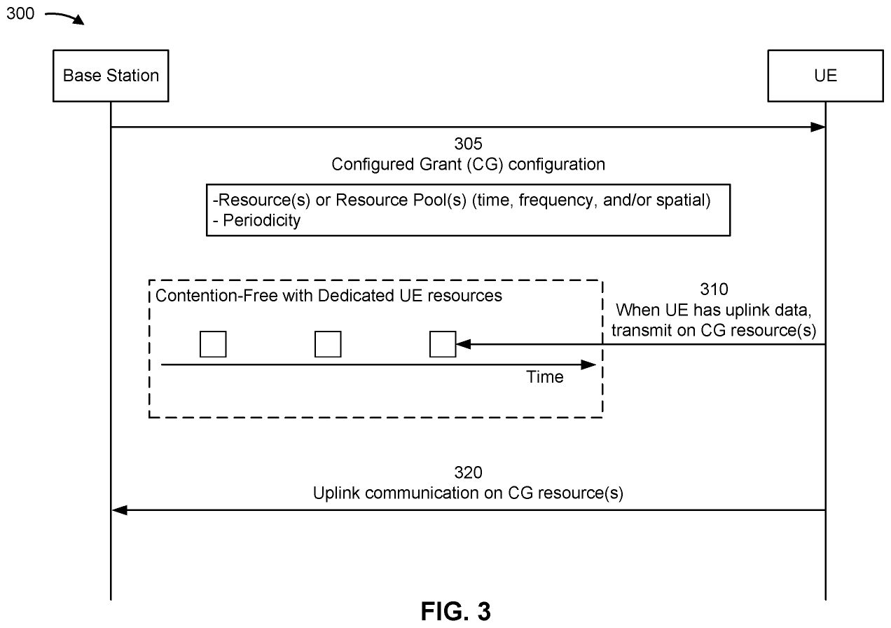

FIG. 3 is a diagram illustrating an example 300 of configured grant (CG) communication, in accordance with various aspects of the present disclosure. As shown, example 300 includes a base station and a UE.

As shown in FIG. 3, and by reference number 305, the base station may transmit a CG configuration to the UE. For example, the base station may transmit configuration information (e.g., in a radio resource configuration (RRC) message, in a downlink control information (DCI) message, and/or the like) that identifies the CG. In some aspects, the configuration information identifying the CG may indicate a resource allocation (e.g., in a time domain, frequency domain, spatial domain, code domain, and/or the like), a periodicity associated with the resource allocation, and/or the like. The CG may identify a resource or set of resources available to the UE for transmission of an uplink communication (e.g., data, control information, and/or the like). For example, the CG configuration may identify a resource allocation for a PUSCH. In some aspects, the CG configuration may identify a resource pool or multiple resource pools that may be available to the UE for an uplink transmission.

In some aspects, the CG configuration may configure contention-free CG communication with resources dedicated for the UE to transmit uplink communications. In this case, the CG configuration may indicate a resource allocation (e.g., in a time domain, frequency domain, spatial domain, code domain, and/or the like) dedicated for the UE to use to transmit uplink communications. In some aspects, the CG configuration may configure the resource allocation for the UE to occur periodically, such that the resource allocation corresponds to periodically occurring transmission time occasions.

As shown in FIG. 3, and by reference number 310, when the UE has uplink data to transmit, the UE transmits the uplink data in the CG resources identified by the CG configuration. For example, the UE transmits the uplink data in one of the CG uplink occasions identified in the CG configuration using the configured resource allocation. A CG configuration with regular periodic CG uplink occasions with a dedicated resource allocation for the UE may be convenient for a UE with periodic uplink traffic. The CG configuration may configure the periodicity associated with the resource allocation to associate CG uplink occasions with periodic nominal arrival times at which traffic to be transmitted to the base station is expected to arrive at (or be ready to be transmitted by) the UE.

As further shown in FIG. 3, and by reference number 320, the UE transmits the uplink communication to the base station on the CG resource. For example, the UE may transmit the uplink communication as a PUSCH communication using a resource allocation identified by the CG.

In this way, the base station may schedule uplink data transmissions for the UE without uplink grants (e.g., without DCI grants). As described above, a configuration for a CG (e.g., ConfiguredGrantConfig) may be a semi-static configuration (e.g., an RRC configuration). In some aspects, a configuration for a CG may be activated (or deactivated) by DCI.

In a first type of CG configuration, referred to as a Type 1 CG configuration (e.g., an RRC-based CG configuration), a UE can perform uplink data transmission without a grant based at least in part on RRC (re)configuration without any Layer 1 (L1) signaling. That is, a Type 1 CG configuration is entirely RRC configured. In a second type of CG configuration, referred to as a Type 2 CG configuration (e.g., a DCI activation-based CG configuration), a UE can perform uplink data transmission without a grant based at least in part on RRC (re)configuration in combination with L1 signaling to activate and/or release the Type 2 CG configuration. That is, a Type 2 CG configuration uses RRC configuration for some parameters, and DCI activating the CG may indicate other parameters for the CG configuration. Here, after activation of the CG by DCI, a UE may perform PUSCH transmissions according to the CG configuration (e.g., a periodicity and an offset of the CG configuration) until another DCI releases the CG.

A Type 1 CG configuration may indicate a configured scheduling radio network temporary identifier (CS-RNTI), which may be used for receiving DCI that schedules a retransmission. The Type 1 CG configuration may indicate a periodicity of the CG. The Type 1 CG configuration may indicate a time domain offset (e.g., timeDomainOffset) that indicates an offset of the CG resource in a time domain (e.g., with respect to system frame number 0 (SFN=0)). The Type 1 CG configuration may indicate a time domain allocation (e.g., timeDomainAllocation) that indicates the configured uplink grant in the time domain. For example, the time domain allocation may include an indication of a starting symbol and a length (e.g., a start and length indicator value (SLIV)). As an example, a time domain allocation parameter of the Type 1 CG configuration may indicate a value (m) that indicates a row index (m+1) of a time domain resource allocation table (which indicates the SLIV). The Type 1 CG configuration may indicate a quantity of hybrid automatic repeat request (HARQ) processes (e.g., nrofHARQ-Processes) for the CG.

A Type 2 CG configuration may indicate a CS-RNTI, which may be used for receiving DCI that activates the Type 2 CG configuration, deactivates the Type 2 CG configuration, and/or schedules a retransmission. The Type 2 CG configuration may indicate a periodicity of the CG. The Type 2 CG configuration may indicate a quantity of HARQ processes (e.g., nrofHARQ-Processes) for the CG. For a Type 2 CG configuration, L1 signaling may indicate additional parameters for the CG resource, such as a time offset associated with the periodicity. For example, a time domain resource allocation field in DCI may indicate a row index of a time domain resource allocation table (which indicates a SLIV). In addition, for a Type 2 CG configuration, a UE may transmit an acknowledgment (e.g., in a medium access control control element (MAC-CE)) for L1 signaling that activates or deactivates the Type 2 CG configuration.

In some cases, a CG configuration may indicate a quantity of consecutive slots that are allocated for a CG resource in a period of the CG. The consecutive slots may begin from a slot offset indicated by the CG configuration. As another example, a CG configuration may indicate a quantity of consecutive PUSCH occasions in a slot (i.e., per slot). A length (e.g., a time duration) of each PUSCH occasion may be the same. For example, a SLIV of the CG configuration may indicate a starting symbol and a length for a first PUSCH occasion in a slot, and the indicated length may be repeated for consecutive PUSCH occasions in the slot. Moreover, a time domain resource assignment of the CG configuration may repeat over the indicated quantity of consecutive slots, and the same symbol allocation and mapping type may be used for a first PUSCH occasion in each slot of the consecutive slots.

In some aspects, a UE may transmit uplink control information (UCI) relating to the CG (which may be referred to as CG-UCI) in each PUSCH transmission of the CG. The CG-UCI may indicate a HARQ process identifier associated with the PUSCH transmission, a new data indication for the PUSCH transmission, a redundancy version associated with the PUSCH transmission, and/or the like. The CG-UCI also may indicate channel occupancy time (COT) sharing information.

As indicated above, FIG. 3 is provided as an example. Other examples may differ from what is described with respect to FIG. 3.

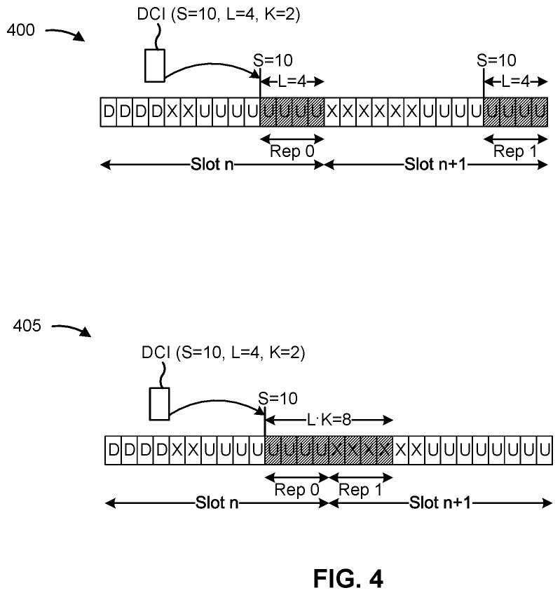

FIG. 4 is a diagram illustrating examples 400 and 405 of physical uplink repetition types, in accordance with various aspects of the present disclosure. In particular, examples 400 and 405 are examples of different types of PUSCH repetition, which may be used for dynamic grants or configured grants. The different types of PUSCH repetition of examples 400 and 405 may be used for ultra-reliable low-latency communication (URLLC). In some aspects, PUSCH repetitions may be defined according to a SLIV, which indicates a starting symbol (S) for a repetition and a length (L) of a repetition (e.g., a quantity of symbols for a repetition), and a quantity of repetitions (K).

Example 400 is an example of PUSCH repetition Type A. In PUSCH repetition Type A, the same SLIV may be used for each repetition in a slot across K consecutive slots (e.g., when K>1). In PUSCH repetition Type A, each repetition is transmitted in a respective slot. Moreover, the same symbol indices are used for a repetition in each of the slots. That is, in each slot, the same starting symbol and the same repetition length (e.g., the same SLIV) is used for a repetition. PUSCH repetition Type A may use dynamic indication of the quantity of repetitions (e.g., in a time domain resource allocation (TDRA) field of DCI), or semi-static configuration of the quantity of repetitions (e.g., in a radio resource control (RRC) configuration). In the case of semi-static configuration, a UE may be configured with a PUSCH aggregation factor (e.g., a pusch-AggregationFactor parameter), and the quantity of repetitions may correspond to the PUSCH aggregation factor. In the case of dynamic indication, a UE may be configured with a TDRA table that includes a plurality of rows, and each row may identify a quantity of repetitions (e.g., in a numberofrepetitions field). Here, the quantity of repetitions may correspond to the quantity of repetitions identified by a row of the TDRA table that is indicated in DCI.

In some aspects (e.g., for PUSCH repetitions scheduled by dynamic grant), if a PUSCH repetition is to be transmitted in a slot that includes one or more symbols configured (e.g., by a semi-static configuration) for downlink communication, the repetition may be skipped (e.g., not transmitted). However, the repetition may still be counted toward the quantity of repetitions (K) that are to be transmitted. For example, if four repetitions are scheduled for a UE, and one of the repetitions is to be transmitted in a slot that includes downlink symbols, then the UE may actually transmit only three of the repetitions.

In connection with a Type 1 CG, the quantity of repetitions may be provided by a higher-layer (e.g., RRC) configured parameter for the quantity of repetitions (e.g., a repK parameter). In connection with a Type 2 CG, the quantity of repetitions may be indicated by DCI that identifies a row of the TDRA table. If rows of the TDRA table do not identify quantities of repetitions (e.g., a numberofrepetitions field is not present in the TDRA table), the quantity of repetitions may be provided by the higher-layer configured parameter (e.g., repK). For a CG, repetition skipping and repetition counting may be performed as described above. Moreover, a UE may determine an error if a time duration for transmission of the quantity of repetitions is greater than a time duration associated with a periodicity for CG occasions.

Example 405 is an example of PUSCH repetition Type B. In PUSCH repetition Type B, K nominal repetitions, each repetition having a nominal length L, are scheduled (e.g., in DCI) back-to-back (e.g., consecutively, without a time gap between the repetitions) starting from symbol S, where S and L are indicated by a SLIV. In PUSCH repetition Type B, the scheduled repetitions are referred to as “nominal repetitions” and the indicated length of a repetition is referred to as a “nominal length,” because an actual quantity of repetitions that are transmitted or an actual length of a repetition that is used may differ from the indicated quantity of nominal repetitions or the indicated nominal length of a repetition.

As described above, a Type A PUSCH repetition may be skipped if the repetition is to be transmitted in a slot that includes one or more symbols configured for downlink communication. However, in some aspects, the skipped repetition (e.g., a slot with downlink symbols in the allocation for the repetitions) may not be counted toward the quantity of repetitions that are to be transmitted. For example, the UE 120 may postpone transmission of the skipped repetition until the next transmission occasion that does not include conflicting downlink symbols. Thus, a UE may actually transmit the indicated or configured quantity of repetitions in slots that do not include conflicting downlink symbols.

In some aspects, inter-slot frequency hopping (e.g., when enabled) may be based on a slot index within a radio frame (e.g., an absolute slot number). For example, PUSCH transmissions in even-indexed slots may be in a first frequency hop (e.g., a frequency location) and PUSCH transmissions in odd-indexed slots may be in a second frequency hop, in accordance with Equation 1:

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} , \qquad Equation 1$$

where nₛμ represents a slot number, RBₛₜₐᵣₜ defines a first frequency hop, and (RBₛₜₐᵣₜ+RB_{offset}) mod N_{BWP}^{size} defines a second frequency hop.

Accordingly, if a UE is to actually transmit, to a base station, the quantity of repetitions in slots that do not include conflicting downlink symbols (which in some cases could be every-other slot), all of, or a majority of, the repetitions may be transmitted in the same frequency hop. Thus, transmissions of the UE may lack frequency diversity, thereby impairing a performance of the transmissions and resulting in retransmissions, additional consumption of network resources, and/or additional consumption of processing resources of the UE and/or the base station, among other examples.

Some techniques and apparatuses described herein provide improved frequency diversity for repetitions transmitted with inter-slot frequency hopping. In some aspects, the frequency hopping may be based at least in part on a chronological indexing of the slots that are to be used for transmission of the repetitions (rather than an absolute indexing of the slots). As described above, the slots that are to be used for the repetitions may be consecutive slots that do not include conflicting downlink resources. In this way, spatial diversity of the repetitions may be improved, thereby reducing retransmissions and conserving network resources and processing resources associated with retransmissions.

In addition, as described above, a UE may determine an error if a time duration for transmission of a quantity of repetitions is greater than a time duration associated with a periodicity for CG occasions. Accordingly, if a UE is to actually transmit, to a base station, the quantity of repetitions in slots that do not include conflicting downlink symbols, the duration for transmission of the repetitions may exceed the duration associated with the periodicity. This is because the duration for transmission of the repetitions is not constant and depends on a quantity of slots that include conflicting downlink symbols, while the configured periodicity for CG occasions is constant. As a result, collisions between repetitions may occur, thereby impairing a performance of the repetitions.

Some techniques and apparatuses described herein address a scenario in which a duration for transmitting repetitions exceeds a duration associated with a periodicity for occasions of a CG. In some aspects, one or more repetitions that exceed the duration associated with the periodicity may be dropped. In this way, collisions between repetitions may be avoided, and a performance of the repetitions may be improved.

In some aspects, a UE that is using multiple beams for multiple-TRP PUSCH repetitions (e.g., Type A repetitions or Type B repetitions) may map the beams to the repetitions to improve time diversity and/or frequency diversity of the repetitions. For example, the beams may be cyclically mapped to the repetitions. Here, a first beam is mapped to a first repetition, a second beam is mapped to a second repetition, the first beam is mapped to a third repetition, the second beam is mapped to a fourth repetition, and so forth (e.g., a beam mapping pattern of beam 1, beam 2, beam 1, beam 2, and so forth). As another example, the beams may be sequentially mapped to the repetitions. Here, a first beam is mapped to a first and a second repetition, a second beam is mapped to a third and a fourth repetition, and so forth (e.g., a beam mapping pattern of beam 1, beam 1, beam 2, beam 2, and so forth). Other mapping patterns may be possible. For example, a first half of the repetitions may be mapped to a first beam and a second half of the repetitions may be mapped to a second beam. As another example, a particular mapping pattern of beams to repetitions may be configured.

In some aspects, for PUSCH repetitions (e.g., Type A repetitions or Type B repetitions) with frequency hopping, beam mapping may be performed at a frequency hop-level. For example, beams may be cyclically mapped to frequency hops, sequentially mapped to frequency hops, half-and-half mapped to frequency hops, among other examples.

Accordingly, if inter-slot frequency hopping is based on an absolute slot index, as described above, then multiple sets of repetitions that are to use different sets of transmission parameters (e.g., different beams) may not be evenly distributed among different frequency hops. For example, all of, or a majority of, the repetitions for a first set of repetitions may be transmitted in the same frequency hop, and all of, or a majority of, the repetitions for a second set of repetitions may be transmitted in the same frequency hop. Thus, transmissions of the UE may lack frequency diversity, as described above.

Some techniques and apparatuses described herein provide improved frequency diversity for multiple sets of repetitions that use different sets of transmission parameters and are transmitted with inter-slot frequency hopping. In some aspects, repetitions of a first set of repetitions (to be transmitted to a first TRP using a first beam) and repetitions of a second set of repetitions (to be transmitted to a second TRP using a second beam) are mapped such that at least one repetition of each of the first set of repetitions and the second set of repetitions is transmitted in a first frequency hop and at least one repetition of each of the first set of repetitions and the second set of repetitions is transmitted in a second frequency hop. In this way, frequency diversity of the repetitions may be improved, thereby reducing retransmissions and conserving network resources and processing resources associated with retransmissions.

As indicated above, FIG. 4 provides examples. Other examples may differ from what is described with regard to FIG. 4.

FIG. 5 is a diagram illustrating an example 500 associated with PUSCH repetitions, in accordance with various aspects of the present disclosure. As shown in FIG. 5, example 500 includes communication between a base station 110 and a UE 120. In some aspects, the base station 110 and the UE 120 may be included in a wireless network, such as the wireless network 100. The base station 110 and the UE 120 may communicate on a wireless access link, which may include an uplink and a downlink.

As shown by reference number 505, the base station 110 may transmit, and the UE 120 may receive, information indicating a quantity of repetitions for a PUSCH transmission (e.g., a transport block). For example, the UE 120 may receive an RRC configuration that indicates the quantity of repetitions (e.g., by a pusch-AggregationFactor parameter), as described above. As another example, the UE 120 may receive DCI that indicates the quantity of repetitions (e.g., by a TDRA identifier that identifies a row of a TDRA table), as described above. The repetitions for the PUSCH transmission may be Type A PUSCH repetitions, as described above. For example, each repetition may be transmitted in a respective time interval (e.g., a respective slot) according to an indicated (e.g., in DCI) start value and length value (e.g., a SLIV).

In some aspects, the repetitions may include a first set of repetitions that are to be transmitted to a first TRP using a first set of transmission parameters, and a second set of repetitions that are to be transmitted to a second TRP using a second set of transmission parameters (e.g., the repetitions may be for transmissions to multiple TRPs, and may be scheduled by a single DCI or multiple DCIs). The first set of transmission parameters and the second set of transmission parameters may be different (e.g., may differ by at least one transmission parameter). A set of transmission parameters may identify an uplink beam, a precoding, and/or a set of uplink power control parameters, among other examples. Accordingly, in some aspects, the first set of transmission parameters and the second set of transmission parameters may identify different uplink beams, different precodings, and/or different power control parameters.

As shown by reference number 510, the UE 120 may determine time intervals (e.g., slots) in which the repetitions are to be transmitted. In some aspects, the UE 120 may be configured to skip repetitions that are to be transmitted in a time interval that includes resources configured for downlink communication (e.g., includes at least one conflicting downlink symbol). The resources configured for downlink communication may be semi-statically configured (e.g., by semi persistent scheduling). In some aspects, the UE 120 may be configured to transmit all of the quantity of repetitions that are indicated for the UE 120. That is, the UE 120 may not count skipped repetitions toward the quantity of repetitions that is to be transmitted by the UE 120. Accordingly, the UE 120 may determine to transmit the quantity of repetitions in consecutive time intervals (e.g., slots) that do not include time resources configured for downlink communication. That is, the UE 120 may transmit the quantity of repetitions in consecutive time intervals that include time resources (e.g., symbols) configured only for uplink communication or for flexible use (e.g., uplink communication or downlink communication).

In some aspects, the UE 120 may determine an indexing of the determined time intervals, which may be based at least in part on an indexing of the repetitions that are to be transmitted in the determined time intervals. In other words, the determined time intervals may be indexed chronologically. For example, the first determined time interval that does not include conflicting downlink time resources may be assigned an index of 0 (k=0), the second determined time interval that does not include conflicting downlink time resources may be assigned an index of 1 (k=1), and so forth. The last determined time interval that does not include conflicting downlink time resources may be assigned an index of k=K— 1, where K is the indicated quantity of repetitions.

Accordingly, the indexing of the determined time intervals (whereby an index is not assigned to time intervals that include conflicting downlink time resources) may be different from an absolute indexing of the time intervals within a radio frame (whereby an index is assigned to every time interval regardless of whether a time interval includes conflicting downlink time resources), as described above. Thus, the indexing of the time intervals may be a modified indexing relative to an absolute indexing of the time intervals.

In some aspects, the repetitions may include multiple sets of repetitions that are to be transmitted using different sets of transmission parameters (e.g., different beams), as described above. Here, the determined time intervals may be indexed chronologically within a set of repetitions. For example, the determined time intervals that are to be used for repetitions of a first set of repetitions may be indexed chronologically (e.g., k=0, k=1), and the determined time intervals that are to be used for repetitions of a second set of repetitions may be indexed chronologically (e.g., k=0, k=1).

In some aspects, the base station 110 may determine time intervals (e.g., slots) in which the repetitions are to be transmitted, as described above. In some aspects, the base station 110 may determine an indexing of the determined time intervals, as described above.

As shown by reference number 515, the UE 120 may transmit, and the base station 110 may receive, the indicated quantity of repetitions. The UE 120 may transmit the indicated quantity of repetitions in the determined time intervals that do not include time resources configured for downlink communication, as described above. In some aspects, the UE 120 may transmit a first set of the repetitions to a first TRP (e.g., using a first beam) and a second set of the repetitions to a second TRP (e.g., using a second beam).

The UE 120 may transmit the indicated quantity of repetitions using frequency hopping. For example, the UE 120 may use inter-slot frequency hopping to transmit the indicated quantity of repetitions. In inter-slot frequency hopping, different frequency hops are in different time intervals (e.g., different slots). For example, the frequency hops may include a first frequency hop and a second frequency hop, which are used in alternating time intervals.

The frequency hopping used by the UE 120 may be based at least in part on the indexing of the determined time intervals (e.g., rather than an absolute indexing of time intervals within a radio frame). In some aspects, the first frequency hop may be used in the determined time intervals associated with one of even index values or odd index values, and the second frequency hop may be used in the determined time intervals associated with the other of even index values or odd index values. For example, the UE 120 may determine the frequency hopping according to Equation 2:

$${RB}_{start} ( k ) = \{ \begin{matrix}{RB}_{start} & k mod 2 = 0 \\ ( {RB}_{start} + {RB}_{offset} ) mod {N}_{BWP}^{size} & k mod 2 = 1\end{matrix} , \qquad Equation 2$$

where k is an index of a determined time interval according to the modified indexing described herein.

Reference number 520 shows an example in which the UE 120 transmits the quantity of repetitions using frequency hopping that is based at least in part on a modified indexing of slots. As shown, the indicated quantity of repetitions may be four repetitions. Accordingly, the UE 120 may determine that the first four slots that do not include downlink resources are to be used for the repetitions. For example, the first slot, the third slot, the fifth slot, and the sixth slot do not include downlink resources and may be used for transmitting PUSCH repetitions. These slots may be indexed chronologically (0 through 3, as shown) according to the modified indexing described herein. Conversely, the second slot and the fourth slot include downlink resources and are not indexed. As shown, the UE 120 may use the first frequency hop in even-indexed slots to transmit repetitions, and the UE 120 may use the second frequency hop in odd-indexed slots to transmit repetitions.

Reference number 525 shows an example in which the UE 120 transmits the quantity of repetitions using frequency hopping that is based at least in part on a modified indexing of slots. In this example, the repetitions may include the first set of repetitions that use first transmission parameters (e.g., a first beam for transmission to a first TRP) and the second set of repetitions that use second transmission parameters (e.g., a second beam for transmission to a second TRP). Repetitions of the first set of repetitions and the second set of repetitions may be scheduled in alternating time intervals. As shown, the indicated quantity of repetitions may be two repetitions for the first set of repetitions and two repetitions for the second set of repetitions (for a total of four repetitions).

Accordingly, the UE 120 may determine that the first four slots that do not include downlink resources are to be used for the repetitions of the first set of repetitions and the second set of repetitions. For example, the first slot, the third slot, the fifth slot, and the sixth slot do not include downlink resources and may be used for transmitting PUSCH repetitions. These slots may be indexed chronologically, within a set of repetitions, according to the modified indexing described herein. For example, slots used for repetitions of the first set of repetitions (the first slot and the fifth slot, as shown) are indexed chronologically, and slots used for repetitions of the second set of repetitions (the third slot and the sixth slot, as shown) are indexed chronologically. Conversely, the second slot and the fourth slot include downlink resources and are not indexed. As shown, the UE 120 may use the first frequency hop in even-indexed slots to transmit repetitions, and the UE 120 may use the second frequency hop in odd-indexed slots to transmit repetitions.

As indicated above, FIG. 5 is provided as an example. Other examples may differ from what is described with respect to FIG. 5.

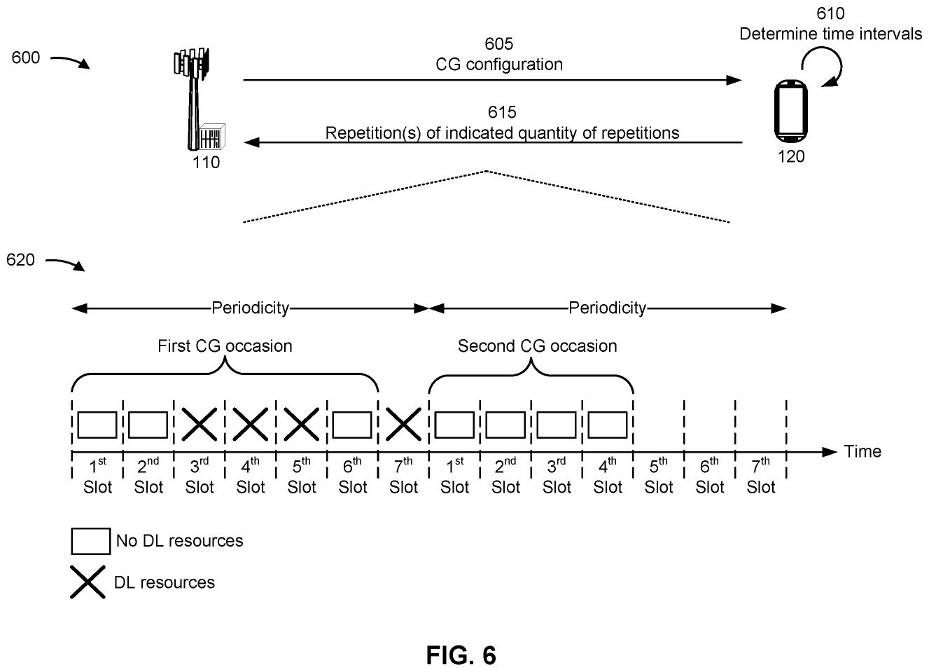

FIG. 6 is a diagram illustrating an example 600 associated with PUSCH repetitions, in accordance with various aspects of the present disclosure. As shown in FIG. 6, example 600 includes communication between a base station 110 and a UE 120. In some aspects, the base station 110 and the UE 120 may be included in a wireless network, such as the wireless network 100. The base station 110 and the UE 120 may communicate on a wireless access link, which may include an uplink and a downlink.

As shown by reference number 605, the base station 110 may transmit, and the UE 120 may receive, a configuration for a configured grant. The configuration may include information that indicates a time domain resource allocation for an occasion of the configured grant. For example, the time domain resource allocation may identify a duration, such as quantity of time intervals (e.g., a quantity of slots), for an occasion of the configured grant. The configuration may include information that indicates a periodicity for occasions of the configured grant. For example, the periodicity may indicate a duration between starting times of consecutive occasions of the configured grant. The duration may be a quantity of time intervals (e.g., a quantity of slots). In some aspects, the duration for an occasion of the configurated grant is less than the duration associated with the periodicity for occasions of the configured grant (e.g., the UE 120 may determine an error if the duration for transmitting the quantity of repetitions in the occasion of the configured grant is greater than the duration associated with the periodicity).

The configuration may include information that indicates a quantity of repetitions of a PUSCH transmission that are to be transmitted in an occasion of the configuration grant. In some aspects, the repetitions are Type A PUSCH repetitions, as described above. For example, each repetition may be transmitted in a respective time interval (e.g., a respective slot) of the occasion of the configured grant according to an indicated (e.g., in DCI) start value and length value (e.g., a SLIV).

In some aspects, the configuration may be for a Type 1 configured grant or a Type 2 configured grant. For example, the UE 120 may receive the configuration via RRC signaling (e.g., for a Type 1 configured grant). As another example, the UE 120 may receive a portion of the configuration via RRC signaling and another portion of the configuration via DCI (e.g., for a Type 2 configured grant). For a Type 1 configured grant, the configuration for the configured grant may be activated by RRC signaling. For a Type 2 configured grant, the configuration for the configured grant may be activated by DCI.

As shown by reference number 610, the UE 120 may determine time intervals (e.g., slots) in which the repetitions for an occasion of the configured grant are to be transmitted. In some aspects, the UE 120 may be configured to skip repetitions that are to be transmitted in a time interval that includes resources configured for downlink communication (e.g., includes at least one conflicting downlink symbol), as described above. In some aspects, the UE 120 may be configured to transmit all of the quantity of repetitions that are indicated for the UE 120, as described above. Accordingly, the UE 120 may determine to transmit the quantity of repetitions in consecutive time intervals (e.g., slots) that do not include time resources configured for downlink communication. That is, the UE 120 may transmit the quantity of repetitions in consecutive time intervals that include time resources (e.g., symbols) configured only for uplink communication or for flexible use.

In some aspects, the determined time intervals may include one or more time intervals outside of a time domain resource allocation for an occasion of the configured grant. In some aspects, a time duration from a first time interval, of the determined time intervals, to a last time interval, of the determined time intervals, may exceed the time duration associated with the periodicity. Here, the UE 120 may determine to transmit less than the quantity of repetitions (e.g., even though the UE 120 is configured to transmit all of the quantity of repetitions). In some aspects, the UE 120 may determine to transmit a lesser quantity of repetitions so that a last repetition to be transmitted by the UE 120 for an occasion of the configured grant ends before a next occasion of the configured grant (e.g., a first slot and/or a first repetition of the next occasion of the configured grant).

In some aspects, the base station 110 may determine time intervals (e.g., slots) in which the repetitions are to be transmitted, as described above. In some aspects, the base station 110 may determine when the UE 120 is to transmit less than the quantity of repetitions indicated for the UE 120, as described above.

As shown by reference number 615, the UE 120 may transmit, and the base station 110 may receive, one or more repetitions of the indicated quantity of repetitions for an occasion of the configured grant. In some aspects, the UE 120 may transmit a first set of the repetitions to a first TRP (e.g., using a first beam) and a second set of the repetitions to a second TRP (e.g., using a second beam). The UE 120 may transmit the repetitions in the determined time intervals that do not include time resources configured for downlink communication, as described above. Moreover, the UE 120 may transmit the repetitions within the time duration (e.g., within the quantity of time intervals) associated with the periodicity. Accordingly, the UE 120 may drop one or more repetitions of the indicated quantity of repetitions that are not transmitted within the time duration associated with the periodicity. That is, the UE 120 may drop one or more repetitions that were determined to exceed the time duration associated with the periodicity.

Reference number 620 shows an example of transmitting repetitions within the time duration associated with the periodicity. In this example, the quantity of repetitions that is to be transmitted by the UE 120 may be four repetitions. In this example, the periodicity for occasions of the configured grant may correspond to seven slots. The UE 120 may determine that the first four slots within a cycle of the periodicity that do not include downlink resources are to be used for the repetitions.

As shown, within a first cycle of the periodicity, only the first slot, the second slot, and the sixth slot do not include downlink resources and may be used for transmitting PUSCH repetitions. Accordingly, the UE 120 may transmit three repetitions for a first occasion of the configured grant within the first cycle of the periodicity (e.g., in the first slot, the second slot, and the sixth slot) and may drop the fourth repetition.

As shown, within a second cycle of the periodicity, the first slot, the second slot, the third slot, and the fourth slot do not include downlink resources and may be used for transmitting PUSCH repetitions. Accordingly, the UE 120 may transmit all four repetitions for a second occasion of the configured grant within the second cycle of the periodicity (e.g., in the first slot, the second slot, the third slot, and the fourth slot). The UE 120 may determine whether to transmit all of the indicated quantity of repetitions, or to transmit a lesser quantity of repetitions, for each occasion of the configured grant, as described above.

As indicated above, FIG. 6 is provided as an example. Other examples may differ from what is described with respect to FIG. 6.

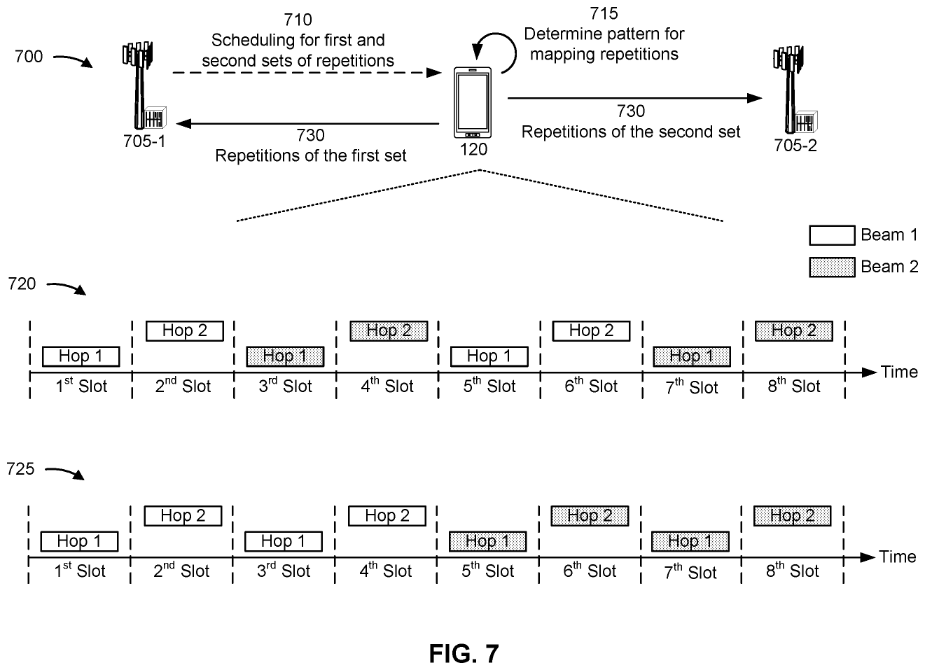

FIG. 7 is a diagram illustrating an example 700 associated with PUSCH repetitions, in accordance with various aspects of the present disclosure. As shown in FIG. 7, example 700 includes communication between a UE 120 and multiple TRPs 705 (shown as a first TRP 705-1 and a second TRP 705-2). In some aspects, the UE 120 and the TRPs 705 may be included in a wireless network, such as the wireless network 100. The UE 120 may communicate with a TRP 705 on a wireless access link, which may include an uplink and a downlink. In some aspects, each TRP 705 may correspond to, may be implemented by, or may be included in, a respective base station 110. In some aspects, the multiple TRPs 705 may be implemented by, or may be included in, the same base station 110.

As shown by reference number 710, the UE 120 may receive information that schedules a first set of repetitions of a PUSCH transmission and a second set of repetitions of the PUSCH transmission. In some aspects, the first set of repetitions and the second set of repetitions are Type A PUSCH repetitions. The UE 120 may receive the information from the first TRP 705-1 and/or the second TRP 705-2 (or another TRP or base station). In some aspects, the information may be included in an RRC configuration or in DCI. For example, the UE 120 may receive scheduling for the first set of repetitions and the second set of repetitions in a single DCI message or in respective DCI messages.

In some aspects, the information may indicate a first quantity of repetitions for the first set of repetitions and a second quantity of repetitions for the second set of repetitions. In some aspects, the first quantity of repetitions and the second quantity of repetitions may be the same quantity of repetitions.

In some aspects, the first set of repetitions are to be transmitted to the first TRP 705-1 using a first set of transmission parameters (e.g., a first beam), and the second set of repetitions are to be transmitted to the second TRP 705-2 using a second set of transmission parameters (e.g., a second beam). The first set of transmission parameters and the second set of transmission parameters may be different, as described above. While example 700 will be described in terms of a first set of repetitions and a second set of repetitions, any number of multiple sets of repetitions scheduled with different respective sets of transmission parameters is contemplated.

In some aspects, the first set of repetitions and the second set of repetitions are to be transmitted using inter-slot frequency hopping (e.g., a frequency hopping flag is set in the DCI(s) scheduling the sets of repetitions), as described above. The frequency hops for the frequency hopping may include a first frequency hop and a second frequency hop, which may be used in alternating time intervals. The UE 120 may determine the time intervals for the first frequency hop and the time intervals for the second frequency hop based at least in part on an absolute indexing of time intervals within a radio frame (e.g., according to Equation 1 above).

As shown by reference number 715, the UE 120 may determine a pattern for mapping repetitions of the first set of repetitions and the second set of repetitions to repetitions that are to be transmitted (e.g., regardless of whether repetitions scheduled in time intervals that include downlink resources are to be skipped and/or regardless of whether skipped repetitions are counted toward a quantity of repetitions to be transmitted). That is, the UE 120 may determine a particular set of transmission parameters (e.g., a particular beam) that is to be used for a particular repetition transmission occasion according to a pattern.

In some aspects, the UE 120 may sequentially map repetitions of the first set of repetitions (e.g., which are to use a first beam) and repetitions of the second set of repetitions (e.g., which are to use a second beam) to repetitions that are to be transmitted by the UE 120 in respective time intervals that alternate between using the first frequency hop and the second frequency hop. In some aspects, the UE 120 may use sequential beam mapping regardless of whether cyclical beam mapping is configured (e.g., RRC configured) for the UE 120. However, if only two repetitions are scheduled to be transmitted by the UE 120, then the UE 120 may map a repetition of the first set of repetitions (e.g., associated with a first beam) to the first repetition of the two repetitions and map a repetition of the second set of repetitions (e.g., associated with a second beam) to the second repetition of the two repetitions (e.g., regardless of whether the mapping results in inter-slot frequency hopping across the two repetitions).

Reference number 720 shows an example of mapping repetitions that use different beams. In this example, a quantity of eight repetitions are to be transmitted by the UE 120 in eight slots. The first frequency hop and the second frequency hop may alternate slots across the eight slots. According to a sequential mapping, the UE 120 may map a repetition of the first set of repetitions to the first frequency hop in the first slot, map a repetition of the first set of repetitions to the second frequency hop in the second slot, map a repetition of the second set of repetitions to the first frequency hop in the third slot, map a repetition of the second set of repetitions to the second frequency hop in the fourth slot, and so forth.

In some aspects, the UE 120 may map repetitions of the first set of repetitions (e.g., which are to use a first beam) and repetitions of the second set of repetitions (e.g., which are to use a second beam) to repetitions that are to be transmitted by the UE 120 in respective time intervals with the first frequency hop, and separately map repetitions of the first set of repetitions and repetitions of the second set of repetitions to repetitions that are to be transmitted by the UE 120 in respective time intervals with the second frequency hop. In some aspects, the UE 120 may use sequential mapping or cyclical mapping for mapping repetitions to time intervals with the same frequency hop.

Reference number 725 shows an example of mapping repetitions that use different beams. In this example, a quantity of eight repetitions are to be transmitted by the UE 120 in eight slots. The first frequency hop and the second frequency hop may alternate slots across the eight slots. According to a sequential mapping, the UE 120 may map a repetition of the first set of repetitions to the first frequency hop in the first slot, map a repetition of the first set of repetitions to the first frequency hop in the third slot, map a repetition of the second set of repetitions to the first frequency hop in the fifth slot, and map a repetition of the second set of repetitions to the first frequency hop in the seventh slot. Similarly, the UE 120 may map a repetition of the first set of repetitions to the second frequency hop in the second slot, map a repetition of the first set of repetitions to the second frequency hop in the fourth slot, map a repetition of the second set of repetitions to the second frequency hop in the sixth slot, and map a repetition of the second set of repetitions to the second frequency hop in the eighth slot.

According to a cyclical mapping, the UE 120 may map a repetition of the first set of repetitions to the first frequency hop in the first slot, map a repetition of the second set of repetitions to the first frequency hop in the third slot, and so forth. Similarly, the UE 120 may map a repetition of the first set of repetitions to the second frequency hop in the second slot, map a repetition of the second set of repetitions to the second frequency hop in the fourth slot, and so forth. This cyclical mapping may result in a mapping shown by reference number 720.

In some aspects, a base station 110 (e.g., a TRP 705) may determine a mapping of repetitions of the first set of repetitions and the second set of repetitions to repetitions that are to be transmitted by the UE 120 in respective time intervals, as described above.

As shown by reference number 730, the UE 120 may transmit repetitions of the first set of repetitions and the second set of repetitions. For example, the UE 120 may transmit repetitions of the first set of repetitions to the first TRP 705-1 (e.g., using a first beam) and repetitions of the second set of repetitions to the second TRP 705-2 (e.g., using a second beam). The UE 120 may transmit the repetitions based at least in part on the mapping determined by the UE 120. For example, the UE 120 may transmit the repetitions so that at least one repetition of each of the first set of repetitions and the second set of repetitions is transmitted in the first frequency hop and at least one repetition of each of the first set of repetitions and the second set of repetitions is transmitted in the second frequency hop.

As indicated above, FIG. 7 is provided as an example. Other examples may differ from what is described with respect to FIG. 7.

FIG. 8 is a diagram illustrating an example process 800 performed, for example, by a UE, in accordance with various aspects of the present disclosure. Example process 800 is an example where the UE (e.g., UE 120) performs operations associated with PUSCH repetitions.

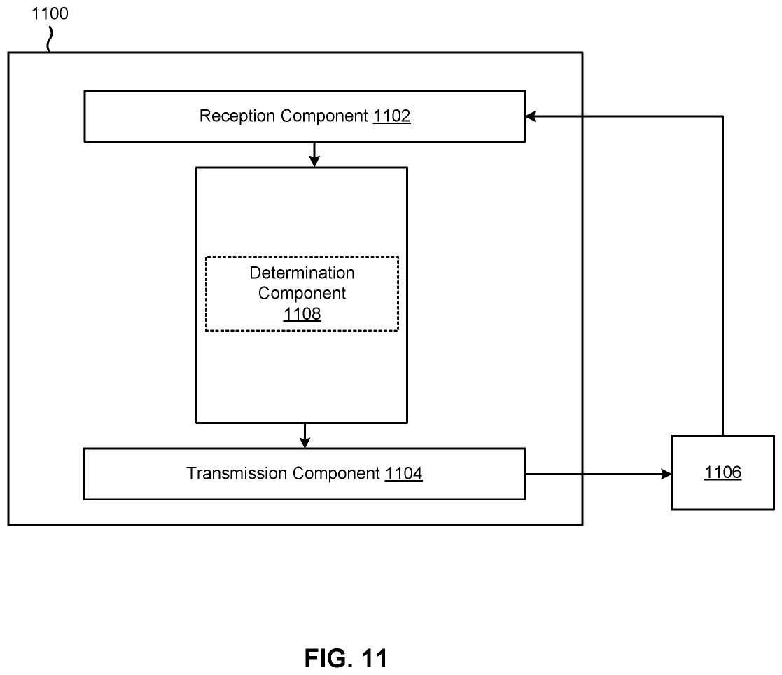

As shown in FIG. 8, in some aspects, process 800 may include receiving information indicating a quantity of repetitions for a PUSCH transmission, where at least one repetition, of the quantity of repetitions, is to be transmitted in a time interval that includes time resources configured for downlink communication (block 810). For example, the UE (e.g., using reception component 1102, depicted in FIG. 11) may receive information indicating a quantity of repetitions for a PUSCH transmission, as described above. In some aspects, at least one repetition, of the quantity of repetitions, is to be transmitted in a time interval that includes time resources configured for downlink communication.

As further shown in FIG. 8, in some aspects, process 800 may include transmitting the quantity of repetitions, in respective time intervals that do not include time resources configured for downlink communication, using frequency hopping that is based at least in part on an indexing of the respective time intervals (block 820). For example, the UE (e.g., using transmission component 1104, depicted in FIG. 11) may transmit the quantity of repetitions, in respective time intervals that do not include time resources configured for downlink communication, using frequency hopping that is based at least in part on an indexing of the respective time intervals, as described above.

Process 800 may include additional aspects, such as any single aspect or any combination of aspects described below and/or in connection with one or more other processes described elsewhere herein.

In a first aspect, a first frequency hop is used in first time intervals, of the respective time intervals, associated with an even index value, and a second frequency hop is used in second time intervals, of the respective time intervals, associated with an odd index value.

In a second aspect, alone or in combination with the first aspect, the quantity of repetitions include a first set of repetitions that are to be transmitted using a first set of transmission parameters and a second set of repetitions that are to be transmitted using a second set of transmission parameters.

In a third aspect, alone or in combination with one or more of the first and second aspects, first time intervals, of the respective time intervals, for the first set of repetitions and second time intervals, of the respective time intervals, for the second set of repetitions are separately indexed.

In a fourth aspect, alone or in combination with one or more of the first through third aspects, a first frequency hop is used in one or more of the first time intervals and one or more of the second time intervals associated with an even index value, and a second frequency hop is used in one or more of the first time intervals and one or more of the second time intervals associated with an odd index value.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a UE, in accordance with various aspects of the present disclosure. Example process 900 is an example where the UE (e.g., UE 120) performs operations associated with PUSCH repetitions.

As shown in FIG. 9, in some aspects, process 900 may include receiving information indicating a periodicity for occasions of a configured grant, where the periodicity for the occasions of the configured grant indicates a quantity of time intervals (block 910). For example, the UE (e.g., using reception component 1102, depicted in FIG. 11) may receive information indicating a periodicity for occasions of a configured grant, as described above. In some aspects, the periodicity for the occasions of the configured grant indicates a quantity of time intervals.

As further shown in FIG. 9, in some aspects, process 900 may include transmitting one or more first repetitions, of a PUSCH transmission for an occasion of the configured grant, in respective time intervals that do not include time resources configured for downlink communication, and dropping one or more second repetitions, of the PUSCH transmission for the occasion of the configured grant, that are not transmitted within the quantity of time intervals (block 920). For example, the UE (e.g., using transmission component 1104, depicted in FIG. 11) may transmit one or more first repetitions, of a PUSCH transmission for an occasion of the configured grant, in respective time intervals that do not include time resources configured for downlink communication, and dropping one or more second repetitions, of the PUSCH transmission for the occasion of the configured grant, that are not transmitted within the quantity of time intervals, as described above.

Process 900 may include additional aspects, such as any single aspect or any combination of aspects described below and/or in connection with one or more other processes described elsewhere herein.

In a first aspect, a last repetition of the one or more first repetitions that are transmitted ends before a next occasion of the configured grant.

In a second aspect, alone or in combination with the first aspect, the configured grant is activated by RRC signaling or DCI.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with various aspects of the present disclosure. Example process 1000 is an example where the UE (e.g., UE 120) performs operations associated with PUSCH repetitions.

As shown in FIG. 10, in some aspects, process 1000 may include receiving information that schedules a first set of repetitions of a PUSCH transmission with a first set of transmission parameters and a second set of repetitions of the PUSCH transmission with a second set of transmission parameters (block 1010). For example, the UE (e.g., using reception component 1102, depicted in FIG. 11) may receive information that schedules a first set of repetitions of a PUSCH transmission with a first set of transmission parameters and a second set of repetitions of the PUSCH transmission with a second set of transmission parameters, as described above.

As further shown in FIG. 10, in some aspects, process 1000 may include transmitting repetitions of the first set of repetitions and the second set of repetitions in respective time intervals, where at least one repetition of each of the first set of repetitions and the second set of repetitions is transmitted in a first frequency hop and at least one repetition of each of the first set of repetitions and the second set of repetitions is transmitted in a second frequency hop (block 1020). For example, the UE (e.g., using transmission component 1104, depicted in FIG. 11) may transmit repetitions of the first set of repetitions and the second set of repetitions in respective time intervals, as described above. In some aspects, at least one repetition of each of the first set of repetitions and the second set of repetitions is transmitted in a first frequency hop and at least one repetition of each of the first set of repetitions and the second set of repetitions is transmitted in a second frequency hop.

Process 1000 may include additional aspects, such as any single aspect or any combination of aspects described below and/or in connection with one or more other processes described elsewhere herein.

In a first aspect, the first set of repetitions and the second set of repetitions are sequentially mapped to the respective time intervals.

In a second aspect, alone or in combination with the first aspect, one or more repetitions of the first set of repetitions and the second set of repetitions are sequentially or cyclically mapped to time intervals, of the respective time intervals, that include the first frequency hop, and one or more repetitions of the first set of repetitions and the second set of repetitions are separately sequentially or cyclically mapped to time intervals, of the respective time intervals, that include the second frequency hop.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include a determination component 1108, among other examples.

In some aspects, the apparatus 1100 may be configured to perform one or more operations described herein in connection with FIGS. 5-7. Additionally, or alternatively, the apparatus 1100 may be configured to perform one or more processes described herein, such as process 800 of FIG. 8, process 900 of FIG. 9, process 1000 of FIG. 10, or a combination thereof. In some aspects, the apparatus 1100 and/or one or more components shown in FIG. 11 may include one or more components of the UE described above in connection with FIG. 2. Additionally, or alternatively, one or more components shown in FIG. 11 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1106. In some aspects, the reception component 1102 may include one or more antennas, a demodulator, a MIMO detector, a receive processor, a controller/processor, a memory, or a combination thereof, of the UE described above in connection with FIG. 2.

The transmission component 1104 may transmit communications, such as reference signals, control information, data communications, or a combination thereof, to the apparatus 1106. In some aspects, one or more other components of the apparatus 1106 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modulator, a transmit MIMO processor, a transmit processor, a controller/processor, a memory, or a combination thereof, of the UE described above in connection with FIG. 2. In some aspects, the transmission component 1104 may be collocated with the reception component 1102 in a transceiver.

The reception component 1102 may receive information indicating a quantity of repetitions for a physical uplink shared channel transmission. In some aspects, at least one repetition, of the quantity of repetitions, is to be transmitted in a time interval that includes time resources configured for downlink communication. The transmission component 1104 may transmit the quantity of repetitions, in respective time intervals that do not include time resources configured for downlink communication, using frequency hopping that is based at least in part on an indexing of the respective time intervals. The determination component 1108 may determine the respective time intervals for transmitting the quantity of repetitions. In some aspects, the determination component 1108 may include a controller/processor, a memory, or a combination thereof, of the UE described above in connection with FIG. 2.

The reception component 1102 may receive information indicating a periodicity for occasions of a configured grant. In some aspects, the periodicity for the occasions of the configured grant indicates a quantity of time intervals. The transmission component 1104 may transmit one or more first repetitions, of a PUSCH transmission for an occasion of the configured grant, in respective time intervals that do not include time resources configured for downlink communication, and dropping one or more second repetitions, of the PUSCH transmission for the occasion of the configured grant, that are not transmitted within the quantity of time intervals. The determination component 1108 may determine the respective time intervals for transmitting the one or more first repetitions of the PUSCH transmission.

The reception component 1102 may receive information that schedules a first set of repetitions of a PUSCH transmission with a first set of transmission parameters and a second set of repetitions of the PUSCH transmission with a second set of transmission parameters. The transmission component 1104 may transmit repetitions of the first set of repetitions and the second set of repetitions in respective time intervals. In some aspects, at least one repetition of each of the first set of repetitions and the second set of repetitions is transmitted in a first frequency hop and at least one repetition of each of the first set of repetitions and the second set of repetitions is transmitted in a second frequency hop. The determination component 1108 may determine a mapping of the first set of repetitions and the second set of repetitions to the respective time intervals.

The quantity and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a user equipment (UE), comprising:
receiving a downlink control information (DCI) message that includes a first field indicating a first transmit precoder matrix indicator (TPMI) index and a quantity of transmission layers and a second field indicating a second TPMI index; and
determining a first precoding matrix for transmitting a first set of repetitions of a physical uplink shared channel (PUSCH) transmission based at least in part on the first TPMI index and the quantity of transmission layers, and a second precoding matrix for transmitting a second set of repetitions of the PUSCH transmission based at least in part on the second TPMI index and the quantity of transmission layers.

2. The method of claim 1, further comprising:
transmitting one or more repetitions of the first set of repetitions using the first precoding matrix and one or more repetitions of the second set of repetitions using the second precoding matrix.

3. The method of claim 1, further comprising:
determining a size of the second field based at least in part on the quantity of transmission layers indicated by the first field.

4. The method of claim 3, wherein the size of the second field is determined further based at least in part on at least one of a quantity of PUSCH antenna ports for the PUSCH transmission, whether a full power mode is configured for the UE, or a codebook subset type configured for the UE.

5. The method of claim 1, further comprising:
determining a size of the second field based at least in part on a maximum quantity of bits used among multiple quantities of transmission layers for a quantity of PUSCH antenna ports for the PUSCH transmission.

6. The method of claim 1, further comprising:
determining a size of the second field based at least in part on a maximum quantity of bits used among multiple quantities of transmission layers for a maximum quantity of ports configured for a sounding reference signal (SRS) resource of an SRS resource set configured for codebook usage.

7. The method of claim 1, wherein the UE is configured to use the second field for a DCI format associated with the DCI message.

8. The method of claim 7, wherein the UE is separately configured for whether the UE is to use the second field for another DCI format.

9. The method of claim 1, wherein the first set of repetitions includes a first set of scheduled repetitions and the second set of repetitions includes a second set of scheduled repetitions.

10. The method of claim 1, wherein the first set of repetitions includes a first set of transmitted repetitions and the second set of repetitions includes a second set of transmitted repetitions.

11. A user equipment (UE) for wireless communication, comprising:
a memory; and
one or more processors operatively coupled to the memory, -the one or more processors configured to:
receive a downlink control information (DCI) message that includes a first field indicating a first transmit precoder matrix indicator (TPMI) index and a quantity of transmission layers and a second field indicating a second TPMI index; and
determine a first precoding matrix for transmitting a first set of repetitions of a physical uplink shared channel (PUSCH) transmission based at least in part on the first TPMI index and the quantity of transmission layers, and a second precoding matrix for transmitting a second set of repetitions of the PUSCH transmission based at least in part on the second TPMI index and the quantity of transmission layers.

12. The UE of claim 11, wherein the one or more processors are further configured to:
transmit one or more repetitions of the first set of repetitions using the first precoding matrix and one or more repetitions of the second set of repetitions using the second precoding matrix.

13. The UE of claim 11, wherein the one or more processors are further configured to:
determine a size of the second field based at least in part on the quantity of transmission layers indicated by the first field.

14. The UE of claim 13, wherein the size of the second field is determined further based at least in part on at least one of a quantity of PUSCH antenna ports for the PUSCH transmission, whether a full power mode is configured for the UE, or a codebook subset type configured for the UE.

15. The UE of claim 1, wherein the one or more processors are further configured to:
determine a size of the second field based at least in part on a maximum quantity of bits used among multiple quantities of transmission layers for a quantity of PUSCH antenna ports for the PUSCH transmission.

16. The UE of claim 11, wherein the one or more processors are further configured to:
determine a size of the second field based at least in part on a maximum quantity of bits used among multiple quantities of transmission layers for a maximum quantity of ports configured for a sounding reference signal (SRS) resource of an SRS resource set configured for codebook usage.

17. The UE of claim 11, wherein the UE is configured to use the second field for a DCI format associated with the DCI message.

18. The UE of claim 17, wherein the UE is separately configured for whether the UE is to use the second field for another DCI format.

19. The UE of claim 11, wherein the first set of repetitions includes a first set of scheduled repetitions and the second set of repetitions includes a second set of scheduled repetitions.

20. The UE of claim 11, wherein the first set of repetitions includes a first set of transmitted repetitions and the second set of repetitions includes a second set of transmitted repetitions.

21. A non-transitory computer-readable medium storing a set of instructions for wireless communication, the set of instructions comprising:
one or more instructions that, when executed by one or more processors of a user equipment (UE), cause the UE to:
receive a downlink control information (DCI) message that includes a first field indicating a first transmit precoder matrix indicator (TPMI) index and a quantity of transmission layers and a second field indicating a second TPMI index; and
determine a first precoding matrix for transmitting a first set of repetitions of a physical uplink shared channel (PUSCH) transmission based at least in part on the first TPMI index and the quantity of transmission layers, and a second precoding matrix for transmitting a second set of repetitions of the PUSCH transmission based at least in part on the second TPMI index and the quantity of transmission layers.

22. An apparatus for wireless communication, comprising:
means for receiving a downlink control information (PUSCH) message that includes a first field indicating a first transmit precoder matrix indicator (TPMI) index and a quantity of transmission layers and a second field indicating a second TPMI index; and
means for determining a first precoding matrix for transmitting a first set of repetitions of a physical uplink shared channel (PUSCH) transmission based at least in part on the first TPMI index and the quantity of transmission layers, and a second precoding matrix for transmitting a second set of repetitions of the PUSCH transmission based at least in part on the second TPMI index and the quantity of transmission layers.

23. The non-transitory computer-readable medium of claim 21, wherein the one or more instructions, when executed by the one or more processors of the UE, further cause the UE to:
transmit one or more repetitions of the first set of repetitions using the first precoding matrix and one or more repetitions of the second set of repetitions using the second precoding matrix.

24. The non-transitory computer-readable medium of claim 21, wherein the one or more instructions, when executed by the one or more processors of the UE, further cause the UE to:
determine a size of the second field based at least in part on the quantity of transmission layers indicated by the first field.

25. The non-transitory computer-readable medium of claim 21, wherein the one or more instructions, when executed by the one or more processors of the UE, further cause the UE to:
determine a size of the second field based at least in part on a maximum quantity of bits used among multiple quantities of transmission layers for a quantity of PUSCH antenna ports for the PUSCH transmission.

26. The non-transitory computer-readable medium of claim 21, wherein the one or more instructions, when executed by the one or more processors of the UE, further cause the UE to:
determine a size of the second field based at least in part on a maximum quantity of bits used among multiple quantities of transmission layers for a maximum quantity of ports configured for a sounding reference signal (SRS) resource of an SRS resource set configured for codebook usage.

27. The apparatus of claim 22, further comprising:
means for transmitting one or more repetitions of the first set of repetitions using the first precoding matrix and one or more repetitions of the second set of repetitions using the second precoding matrix.

28. The apparatus of claim 22, further comprising:
means for determining a size of the second field based at least in part on the quantity of transmission layers indicated by the first field.

29. The apparatus of claim 22, further comprising:
means for determining a size of the second field based at least in part on a maximum quantity of bits used among multiple quantities of transmission layers for a quantity of PUSCH antenna ports for the PUSCH transmission.

30. The apparatus of claim 22, further comprising:
means for determining a size of the second field based at least in part on a maximum quantity of bits used among multiple quantities of transmission layers for a maximum quantity of ports configured for a sounding reference signal (SRS) resource of an SRS resource set configured for codebook usage.
